(19) United States
(12) Patent Application Publication
(10) Pub. No.: US 2022/0227059 A1
(43) Pub. Date: Jul. 21, 2022

(54) TEMPERATURE MEASUREMENT CALIBRATION IN 3D PRINTING

(71) Applicant: HEWLETT-PACKARD DEVELOPMENT COMPANY, L.P., SPRING, TX (US)

(72) Inventors: Marc Borras Camarasa, Sant Cugat del Valles (ES); Davinia Font Calafell, Sant Cugat del Valles (ES); Ismael Chanclon Fernandez, Sant Cugat del Valles (ES); Emilio Sapena Masip, Sant Cugat del Valles (ES); Hector Vega Ponce, Sant Cugat del Valles (ES)

(73) Assignee: HEWLETT-PACKARD DEVELOPMENT COMPANY, L.P., SPRING, TX (US)

(21) Appl. No.: 17/609,505

(22) PCT Filed: Oct. 25, 2019
(86) PCT No.: PCT/US2019/058122

§ 371 Date: Nov. 8, 2021

(51) Int. Cl. B29C 64/393; G01J 5/80; B29C 64/153; B22F 10/28; B22F 10/368; B22F 12/90; B33Y 10/00; B33Y 30/00; B33Y 50/02

(52) U.S. Cl. CPC B29C 64/393; G01J 5/80; B29C 64/153; B22F 10/28; B33Y 50/02; B22F 12/90; B33Y 10/00; B33Y 30/00; B22F 10/368

(57) ABSTRACT

Examples described herein relate to a method of 3D printing. In an example, at least part of a layer of build material is fused. The temperatures of the fused part of the layer are measured at different locations using respective temperature sensors. The temperature sensors are calibrated using the measured temperatures. Heating of additional layers of build material is controlled using the calibrated temperature sensors.

### BACKGROUND

Three-dimensional objects may be produced by additive manufacturing processes which generate the object layer by layer using a three-dimensional (3D) printer. Example 3D printers may use build material fusion technologies in which fusion (sintering or melting) between some build material particles or fibers of plastic, metal, ceramic or other powders or fibers is performed one layer at a time. The unfused particles may be removed or reused, leaving the solid printed object.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 illustrates an example three-dimensional printer;

FIG. 2 illustrates a plan view of a calibration object according to an example;

FIG. 3 illustrates a plan view of a calibration layer according to an example;

FIG. 4 is a flowchart of an example method of calibrating temperature sensors according to an example;

FIG. 5 illustrates a thermal camera image of a calibration object according to an example;

FIG. 6 illustrates measured temperatures of a calibration object according to an example;

FIG. 7 illustrates a thermal camera image of a calibration layer according to an example; and

FIG. 8 is a schematic of a processor and a computer readable storage medium with instructions stored thereon according to an example.

### DETAILED DESCRIPTION

In some examples of three-dimensional (3D) printing, 3D objects are formed using thermal, piezo other printhead inkjet arrays. A layer of build material (eg a powder or fibers of plastic, ceramic or metal) is exposed to radiation, such that the build material is fused and hardened to become a layer of a 3D object. In some examples, a coalescent or fusing agent is selectively deposited (or “printed”) in contact with a selected region of the build material. The fusing agent is capable of penetrating into the layer of build material and spreading onto the exterior surface of the build material. The fusing agent is capable of absorbing radiation (e.g., thermal radiation, broadly referred herein as heat), which in turn melts or sinters the build material that is in contact with the fusing agent. This causes the build material to fuse or bind to form a layer of the 3D object. Repeating this process with numerous layers of build material causes the layers to be joined together, resulting in the formation of the 3D object.

In some 3D printing systems, a support member (e.g., also known as a powder bed) and any layers of build material are heated (broadly heating) to a certain target temperature range less than the temperature used for fusing. This temperature range is maintained throughout the 3D printing process and reduces the time for the fusing process and in addition also provides some uniformity of temperature of the build material during the 3D printing process which improves the quality of the finished objects. This heating can be provided using overhead lamps or short-wave infrared (IR) emitters deployed within the 3D object printing system to perform this pre-heating process.

In some non-limiting examples, the build material may be a powder-based build material, which may include both dry and wet powder-based material, particulate materials and granular materials. In some examples, the build material may include a mixture of air and solid polymer particles, for example at a ratio of about 40% air and about 60% solid polymer particles. According to one example, a suitable fusing agent may be an ink-type formulation comprising carbon black, such as, for example, the fusing agent formulation commercially known as V1Q60A “HP fusing agent” available from HP Inc. In one example such a fusing agent may additionally comprise an infra-red light absorber. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc.

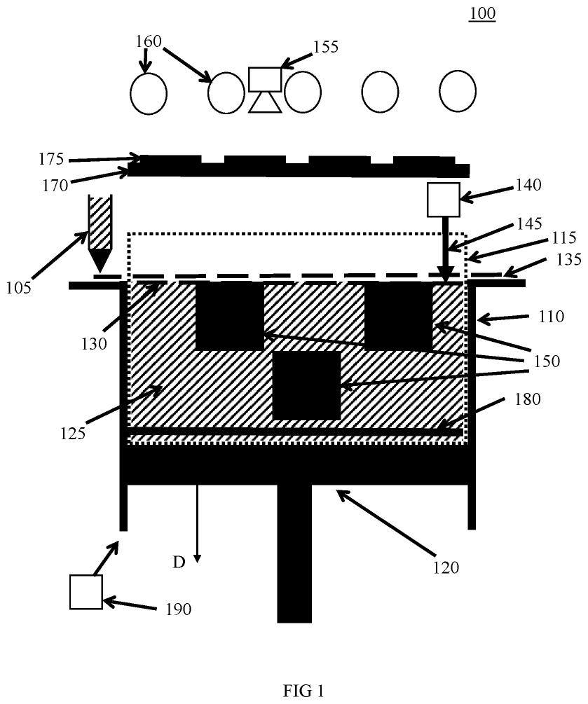

FIG. 1 illustrates one example of a 3D printing apparatus. The 3D printing apparatus or printer 100 is used to print a number of objects 150 and comprises a build chamber having build chamber walls 110 and a support member or build platform 120. The build platform 120 supports a plurality of layers of build material 125 and is movable during generation of the 3D object to accommodate each new layer of build material. The movement of the build platform 120 during layer by layer building of the 3D object is shown by arrow D. The build chamber has a build or printing volume 115 which is defined by the build chamber walls and the build platform when in its lowest position. In this example, the build volume 115 will therefore be at or below the top of the build chamber walls 110 when the last layer of build material has been added. For the purposes of the following explanation, a current or most recent layer 130 is shown at the highest level of the layers of build material 125, and a new or next layer 135 is indicated immediately above the current layer.

A build material distributor 105 is arranged to spread a layer of build material, such as a plastic or metal powder, at the top of the build chamber walls 110, along the line 135. A printhead (not shown) with nozzles is arranged to selectively direct or print a fusing agent to the top or new layer of build material. The fusing agent is a material that, when a suitable amount of energy is applied to a combination of build material and fusing agent, causes the build material to melt, sinter, fuse or otherwise coalesce and solidify. Example fusing agents include carbon black and liquids containing near infrared absorbent. The fusing agent may increase heating of the build material by acting as an energy absorbing agent that can cause the build material on which it has been deposited to absorb more energy (e.g. from a radiation source) than build material on which no agent has been deposited.

Preheating of the build material may be arranged to bring and maintain the temperature of the build material to close to the melting or fusing temperature of the build material. Application of the fusing agent to the build material layer may cause, during a subsequent application of energy to irradiate the build material, localized heating of the region of build material to a temperature above melting or fusing temperature. This can cause the region of build material to melt, sinter, coalesce or fuse, and then solidify after cooling. In this manner, solid parts of the object may be constructed. Preheating may be implemented using overhead heating lamps 160, however other arrangements are possible including moveable heating sources such as one or more infrared transmitters.

In certain examples, another printhead (not shown) may be used to apply a detailing agent to the new layer of build material. The detailing agent may act to modify the effect of the fusing agent and/or directly act to cool build material. This can result in more accurate definition of the solid parts of the object.

In the example a fusing energy source 140 is arranged to apply sufficient heat energy 145 to the layer of build material to cause local fusing. The heating apparatus 145 may comprise a high power movable infrared source providing an infrared beam 145 which moves across the layer of build material causing the parts of the layer having the fusing agent to fuse and form the solid parts of the object. The remaining parts of the layer of build material are left unfused. In an alternative arrangement, a series of infrared sources may be statically located adjacent the top layer of build material and operated to cause the same fusing process. The 3D printer 100 also comprises a controller 190 which operates the various described parts.

The 3D printer 100 also comprises one or more thermal cameras 155 having multiple temperature sensors 320 in the form of pixels of the camera and which measure the temperature at portions of the current layer of build material 130. Following fusing of this layer, areas of build material corresponding to parts of the object will have been exposed to heat energy to fuse the build material whereas other areas of the build material will have been heated but not fused. This means that parts of the current layer 130 will have a higher temperature than other parts immediately following fusing. The temperatures measured at different locations using different temperature sensors or pixels are used to control operation of the printing apparatus 100, including controlling the overhead lamps 160 to adjust preheating and controlling the intensity and speed of travel of the fusing energy source.

In an example the temperature sensors are pixels in a FLIR thermocamera 155 such as those supplied by Heimann Sensors GmBH and are used to measure infrared radiation to determine temperatures at different locations within their field of view. Each of the pixels of the or each camera corresponds to a respective location of the current layer 130. Other types of temperature sensors may alternatively be used in other examples.

In order to calibrate these temperature sensors their measurements of one or more calibration objects at a known temperature are used as described in more detail below. In an example these calibration objects are located in a fusing zone at the same distance from the temperature sensors as the layer being fused 130; although in other examples different distances may be used. In examples differences between the temperature measurements of the different temperature sensors may be used for calibrating the temperature sensors and/or comparison of the temperature measurements with a known temperature of the calibration objects may also or alternatively be used for calibration. In an example the known temperature is the fusing temperature of the build material, although other temperatures may be used in other examples.

In an example, a calibration object 170 may be used, for example a black body tool. The black body tool is a reference source with an emissivity of 1 (or close to this in practice) which provides a known and constant temperature. The black body tool may be heated to a known temperature using an external heat source or the heating lamps 160. An example material is matt black anodize aluminum. Whilst the calibration object is shown above the fusing zone in the figure this is merely for clarity and in practice for calibration of the sensors in this example the black body 170 would be located at the same location as the fusing layer 130, typically when the chamber is empty of build material for the purpose of calibrating the temperature sensors. In other examples the black body 170 may be located at different distances from the sensors 155, 320.

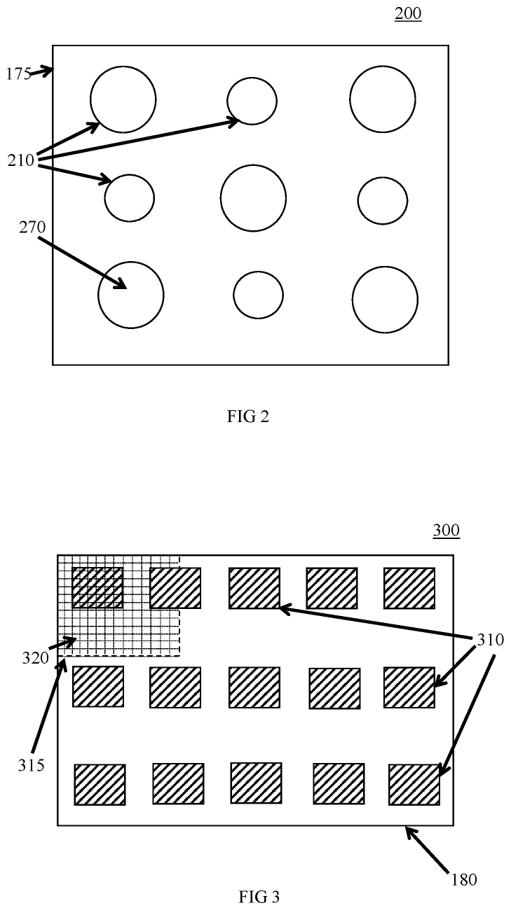

In an example, a shield 175 having holes therethrough is located above the calibration object 170, between this and the temperature sensors 320 in the thermocamera 155. A plan view of the shield 175 is shown in FIG. 2. The shield 175 includes a number of holes 210 to expose isolated regions 270 of the underlying blackbody. The regions 270 are separated from each other by the shield 175 so that the holes will be seen by the camera 155 as regions of increased temperature compared with the surrounding shield which will have a lower temperature. As noted above, during calibration of the sensors 155, 320, the calibration object 170 and shield 175 with holes 210 are located at the same distance from the sensors as the distance at which fusing of build material occurs during production. The calibration object and shield may be installed manually in this fusing zone or this may be accomplished using an automated mechanical apparatus. In other examples, different distances may be used for calibration. In an example the blackbody 170 is heated to 150 degrees, however other temperatures could be used including the fusing temperature of the build material. for the build material to be used by the printing apparatus 100 in production of objects 150. Therefore, the temperature sensors will measure temperatures of the calibration object 170 at a plurality of locations across the build material fusing one 130 and corresponding to the holes 270.

It has been found that measuring the temperatures of isolated regions 270 of the blackbody can improve the accuracy of the temperature measurements of the temperature sensors, compared with measuring the temperatures of the entire blackbody and/or across the entire fusing zone 130. This is may be due to reduced electrical crosstalk between adjacent pixels of the thermocamera; also the isolated regions or spots are more representative of what the thermocamera will see during the printing process.

Referring again to FIG. 1, in another example, the calibration object is a fused layer 180 of build material. The calibration takes place when the calibration layer 180 is at the fusing zone 130 and is or have just been fused. However, calibration can also take place at other distances from the sensors following fusing of the calibration layer. At these points, the portions of the calibration layer which have been fused will have a known fusing temperature which can be measured by the temperature sensors. The calibration layer 180 may be used within a build job so that subsequently fused objects 150 may be generated following the fusing and measuring of the calibration layer 180. The temperature sensors may then be calibrated and used to control generation of preheating and fusing of subsequent to generate the objections 150. The calibration layer 180 may be the first or an early layer in the build job, followed by other layers of build material used to make the objects 150. This allows for continuous calibration of the temperature sensors as the printing apparatus cycles through different production jobs. This in turn allows for more accurate temperature measurements and hence more accurate control of the preheating and/or fusing processes which improves the quality of the fused objects 150. This also allows for better control if the sensors degrade over time, including at different rates. For example, if a degradation occurs in an edge sensor due to a gas leak but the degradation does not reach the center sensor until later, the calibration can accommodate this because it is performed regularly, for example every printing run. A learning algorithm may be used to correct errors across the sensors over time.

FIG. 3 shows a plan view of the calibration layer 180 following fusing. The calibration layer 180 is fused into a plurality of patches or separated areas 310 of build material. These separated areas 310 are separated from each other by regions of unfused building material 125. As with the blackbody example above, the use of isolated locations of calibration objects 310 at a known temperature, the fusing temperature of the build material, improves the calibration of the temperature sensors. Correspondence between locations of the calibration layer 180 and pixels or temperature sensors 320 is illustrated in a section 315 of the thermocamera view overlaid on the calibration layer 180. As will be appreciated, some pixels corresponding to the location of fused parts of the calibration layer will measure the fusing temperature of the build material and other pixels corresponding to unfused build material will measure a lower temperature.

Whilst a series of fused square patches 310 are shown, different shapes and numbers of separated areas of fused building material may be used in other examples. Similarly, in another example a fully fused calibration layer may be used so that all pixels or temperature sensors are exposed to build material at the fusing temperature.

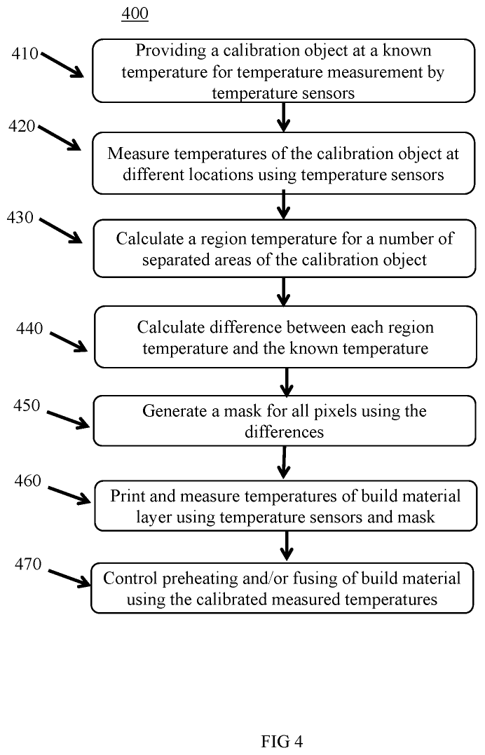

FIG. 4 illustrates a method of calibrating the temperature sensors 320 according to an example, and which may utilize either the shielded blackbody 170, 175 or the calibration layer 180 described above. In some examples, the method 400 is performed by a controller controlling a 3D printing apparatus such as controller 190 and printing apparatus 100.

At item 410, one or more calibration objects are provided for temperature measurement by a plurality of temperature sensors such as pixels 320 of one or more thermal cameras 155. In an example, the calibration objects may be separated areas or isolated locations of a calibration object such as the previously described blackbody 170 and shield 175. The blackbody may be heated to a known temperature such as at or near the fusing temperature of build material to be used in the printing apparatus. This may be achieved using an external heat source or the heating lamps of the 3D printing apparatus. In another example, the calibration objects may be one or more fused parts of a layer of build material, such as the patches of fused building material 310 previously described. The fusing temperature of the build material may be determined using external equipment or from the specification associated with the build material. In another example a fully fused layer of building material may be

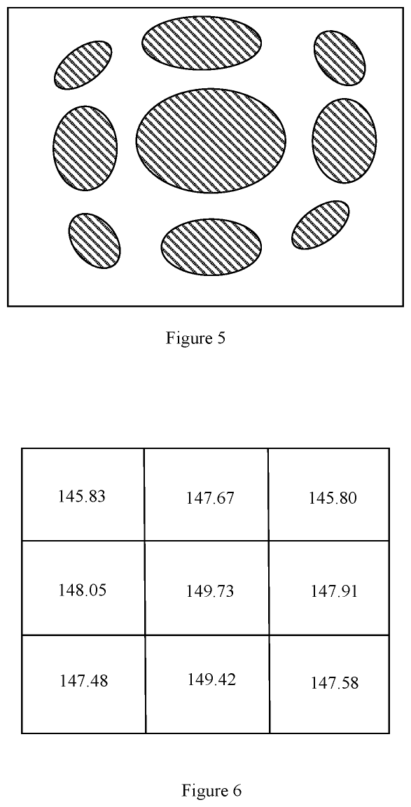

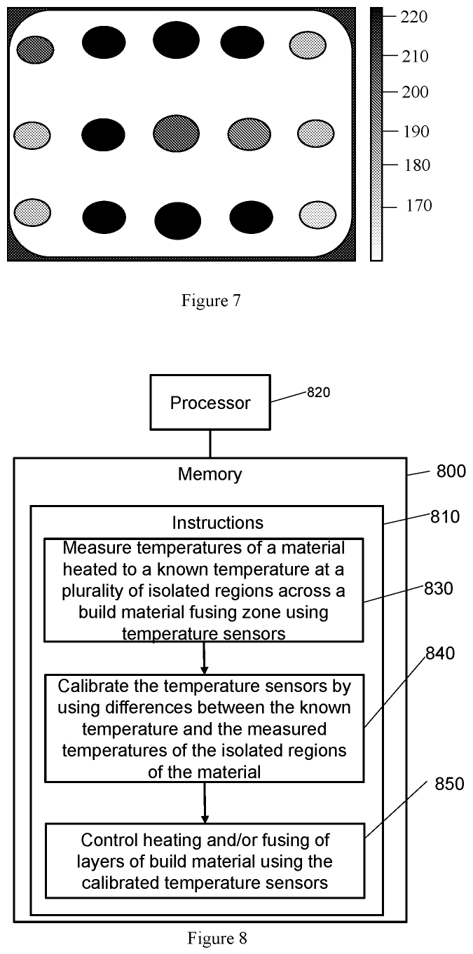

At item 420, temperatures of the calibration object are measured using the temperature sensors. In an example, each pixel of a thermocamera measures the infrared radiation emitted from the calibration object at a respective location. This information may be converted into a temperature signal by the camera or may be provided to a controller which performs the conversion. FIGS. 5 and 7 illustrate a thermocamera images showing temperatures at each pixel. This shows pixels measuring a higher temperature with a darker shade, and with darker regions corresponding to the fused patches.

At item 430, region temperatures for a number of separated areas of the calibration objects are calculated. The separated areas may be patches of melted build material or holes in shielding over a black body object. In an example the region temperatures may be the average of the temperature measurements of the pixels corresponding to the separated areas. These may be weighted with the fit quality of the pixel temperature measurements in the respective separated areas. The calculated region temperatures may be assigned to the center location of each separated area such as patch of melted build material or shield hole over a black body object.

At item 440, the differences between the region temperatures and the known temperature are calculated. An example of region temperatures is shown in FIG. 6 for the pixel measurements of the holes shown in FIG. 5.

In an alternative example, differences may be determined between the known temperature and the temperature measurement of each pixel corresponding to a fused patch of build material or a hole in the shield over a blackbody.

At item 450, a mask is generated for all pixels 320 using these differences. The mask is a correction or calibration value for each pixel, for example an amount to add or subtract (offset) to the temperature measurements of each respective pixel when these are used in a print job to generate objects. In another example the mask may provide a scaling factor with which to multiply the temperature measurement of each pixel. An example showing the region temperatures from FIG. 6 together with masks showing offset and scaling correction values respectively is shown below:

| | | |
|---|---|---|
| 145.83 | 147.67 | 145.8 |
| 148.05 | 149.73 | 147.91 |
| 147.48 | 149.42 | 147.58 |
| −4.17 | −2.33 | −4.20 |
| −1.95 | −0.27 | −2.09 |
| −2.52 | −0.58 | −2.42 |
| 0.972 | 0.984 | 0.972 |
| 0.987 | 0.998 | 0.986 |
| 0.983 | 0.996 | 0.984 |

The mask may include other corrections, for example to account for different cooling rates across a layer of build material following fusing which may affect the known temperature used. This may be determined experimentally and the additional correction for each location of the build material layer incorporated into the mask correction value for the corresponding pixel. For example if the experimentally measured temperature at fused patches at the right of the layer are 1.2 C lower than those on the left when the thermal image is taken, due to cooling whilst fusing continues right to left, then an additional offset of 1.2 may be applied to the mask values for those locations. Further variations in emissivity due to angle may also be corrected for in the mask, for example the thermal energy measured at a corner of the layer may be lower than in the center even though the calibration object, for example the black body tool, is at the same temperature. Again, these differences can be determined experimentally and a correction added to the mask.

In the mask above, corrections or calibration values are given for pixels corresponding to each region temperature for respective separated areas. Calibration values for different areas may be determined by using different calibration objects, for example another shield having a different arrangement of holes over the blackbody or another layer of build material having a different pattern of fused patches. Calibration values for this may be added into the previous mask to increase its coverage and accuracy. Additionally or alternatively, interpolation may be used to include calibration values for all locations across the build layer. The correction values of the above mask correspond to the locations at the center of each patch of fused build material 310 or shield hole 210. A linear interpolation may be used to determine correction values for locations and their corresponding pixels at intermediate positions.

At item 460, the printing continues but the temperatures are measured with the calibrated temperature sensors. That is the temperatures measured by the temperature sensors are corrected using the calibration mask by adding or subtracting the temperature values (or scaling them) as previously described. This may correspond to continuing to apply layers of build material and fusing to generate 3D objects.

At item 470, a heating process for printing 3D objects is controlled using the calibrated temperature measurements from the temperature sensors. The heating process may be preheating and/or fusing of build material. As previously noted, this can improve the accuracy and finish of the generated 3D objects 150.

More accurate temperature measurements lead to improved rendering of printed 3D objects including reducing shape distortions, thermal bleed and surface artifacts such as “elephant skin”. The more accurate temperature measurements also increase the part quality repeatability and yield, and also the thermocamera yield to be reduced. This calibration can also be performed for every job so that any degradations can be corrected in real time. The calibration can take account of the emissivity of the build material with angle. Also there is no need for the use of external calibration equipment.

In another example the blackbody 170 and shield 175 are used to calibrate the temperature sensors. FIG. 5 shows a thermal camera image of the blackbody object and shield with the exposed spots or isolated regions of the blackbody object shown in a darker shade. FIG. 6 shows a table with temperature measurements corresponding to each isolated region. This may be from a central pixel within each region or an average of all measurements of each region. Measuring these temperatures using the temperature sensors corresponds to item 420 in the flow chart of FIG. 4, and determining the temperature to be used for each isolated region corresponds to item 430. This may include taking multiple readings or temperature measurements over a number of thermal camera images and averaging the measured temperature for each pixel or each isolated region.

At item 440, pixels that do not correspond with the blackbody spots 310 or isolated regions are removed. For the remaining isolated areas the differences between each (average) measured temperature is calculated by subtracting the region temperature from the known temperature of the blackbody object.

At item 450, a mask is generated which is a correction factor or value for each isolated region and corresponds to the differential between the region temperature and the known temperature of the blackbody. A mask containing corrections for each pixel may be determined using interpolation as previously described. Alternatively, temperature differences between each pixel and the known temperature may be determined and used to generate respective corrections. The correction factors may be additive/subtractive based on these differences, or they could be multiplicative.

At item 460, once the mask has been generated and is subsequently applied to temperature measurements from the temperature sensors, the blackbody tool is removed, and 3D printing may be commenced as previously described. At item 470, control of a heating process used in the 3D printing is performed using the measured temperatures corrected using the mask. In examples the heating process may be a pre-heating process and/or a fusing process.

The use of the examples can provide correction of temperate measurements, which can be 3 to 4 degrees difference between the corners and center of some thermal cameras. More accurate temperature measurements lead to improved rendering of printed 3D objects including reducing shape distortions, thermal bleed and surface artifacts such as “elephant skin”. The more accurate temperature measurements also increase the part quality repeatability and yield, and also the thermocamera yield to be reduced.

FIG. 8 shows a computer-readable storage medium 800, which may be arranged to implement certain examples described herein. The computer-readable storage medium 800 comprises a set of computer-readable instructions 810 stored thereon. The computer-readable instructions 810 may be executed by a processor 820 connectably coupled to the computer-readable storage medium 800. The processor 820 may be a processor of a printing system similar to printing system 100. In some examples, the processor 820 is a processor of a controller such as controller 190.

Instruction 830 instructs the processor 820 to measure temperatures of a material heated to a known temperature at a plurality of isolated regions across a build material fusing zone using temperature sensors. The calibration object may be the blackbody object 170 and shield 175 previously described and the isolated regions may correspond to holes 210 in the shield. In other examples the isolated regions may be patches of fused building material. The fusing zone may correspond to the height and area of a layer of build material 130 being fused to generate part of the 3D printed object 150. The temperature sensors may be pixels 320 of a thermocamera 155. Different types of thermal cameras may be employed, for example microbolometer or pyrometer. Different types of sensors may be employed including multiple small resolution thermal cameras or any array of pyrometers.

Instruction 840 instructs the processor 820 to calibrate the temperature sensors by using differences between the known temperature and the measured temperatures of the isolated regions of the calibration object. These may be used to calculate correction factors for the temperature sensors using one of the previously described algorithms. These correction factors can then be applied to subsequent measurements of the temperature sensors.

Instruction 850 instructs the processor 820 to control heating and/or fusing of layers of build material using the calibrated temperature sensors. The corrected temperature measurements of the temperature sensors are used in closed loop processes such as maintaining a uniform preheating temperature of the build layers.

Processor 820 can include a microprocessor, microcontroller, processor module or subsystem, programmable integrated circuit, programmable gate array, or another control or computing device. The computer-readable storage medium 800 can be implemented as one or multiple computer-readable storage media. The computer-readable storage medium 800 includes different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 810 can be stored on one computer-readable storage medium, or alternatively, can be stored on multiple computer-readable storage media. The computer-readable storage medium 800 or media can be located either in the printing system 800 or located at a remote site from which computer-readable instructions can be downloaded over a network for execution by the processor 820.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with any features described, and may also be used in combination with any feature of any other examples, or any combination of any other examples.

What is claimed is:

1. A method comprising:
fusing at least part of a layer of build material;
measuring temperatures of the fused part of the layer at different locations using respective temperature sensors and calibrating the temperature sensors using the measured temperatures; and
controlling heating of additional layers of build material using the calibrated temperature sensors.

2. The method of claim 1, wherein the temperature sensors are pixels of a thermal camera.

3. The method of claim 1, wherein calibration of the temperature sensors comprises determining differences between the temperature measurements and a known fusing temperature.

4. The method of claim 3, wherein the calibration of the sensors comprises generating a mask of offset or scaling calibration values for each temperature sensor.

5. The method of claim 1, wherein fusing at least a part of the layer of build material comprises fusing a plurality of separated areas of the layer, the separated areas being separated from each other by unfused regions of the layer.

6. The method of claim 5, wherein calibration of the temperature sensors comprises:
determining a region temperature for each separated area of the layer;
determining differences between the region temperatures and a known fusing temperature;
using the determined differences to generate a mask of offset or scaling calibration values for each temperature sensor.

7. The method of claim 6, wherein the region temperature for each separate area of the layer is the average of the temperature measurements of each temperature sensor corresponding to the respective separate area.

8. The method of claim 6, wherein the calibration values for each temperature sensor are generated by allocating the region temperatures to a central sensor of the respective separate area and interpolating the calibration value for each other sensor from the central sensors.

9. The method of claim 1, wherein controlling heating comprises one or more of the following: preheating the layers of build material; fusing build material.

10. A 3D printing apparatus comprising:
a fusing energy source arranged to fuse layers of build material;
temperature sensors to measure temperatures of the layers of build material;
a preheat source to control the temperature of the layers of build material;
a processor to calibrate the temperature sensors by measuring temperatures at different locations using respective temperature sensors of a fused part of a layer.

11. The apparatus of claim 8, wherein the temperature sensors are pixels of a thermal camera.

12. The apparatus of claim 8, the processor to fuse portions of the layer used to calibrate the temperature sensors into a plurality of areas separated from each other by unfused regions of the layer and to calibrate the temperature sensors by determining differences between the temperature measurements and a known fusing temperature.

13. A non-transitory computer-readable storage medium comprising a set of computer-readable instructions that, when executed by a processor, cause the processor to:
measure temperatures of a calibration object heated to a known temperature at a plurality of isolated regions in a 3D printing apparatus using temperature sensors;
calibrate the temperature sensors by using differences between the known temperature and the measured temperatures of the isolated regions of the material;
control of layers of build material using the calibrated temperature sensors.

14. The non-transitory computer-readable storage medium of claim 13, wherein the calibration object is a blackbody object with shielding to expose the isolated regions of the blackbody object.

15. The non-transitory computer-readable storage medium of claim 13, causing the processor to generate a mask of offset or scaling calibration values for each temperature sensor using differences between respective measured temperatures and the known temperature.
